(19) United States
(12) Patent Application Publication
(10) Pub. No.: US 2006/0144512 A1
(43) Pub. Date: Jul. 6, 2006

(54) Handheld tape applicator for building construction and methods of use thereof

(76) Inventors: Michael Carroll, Loganville, GA (US); John Bennett, Nicholson, GA (US); Richard D. Jordan, Lawrenceville, GA (US)

Correspondence Address: Huber Engineered Woods L.L.C.;c/o J.M. Huber Corporation, Law Department, 333 Thornall Street, Edison, NJ, 08837-2220, US

(21) Appl. No.: 11/028,324

(22) Filed: Jan. 4, 2005

(51) Int. Cl. B32B 37/00; B32B 37/18

(52) U.S. Cl. 156/304.3; 156/574; 156/577; 156/579; 156/91; 156/92; 156/304.1

(57) ABSTRACT

A hand-grippable adhesive tape applicator is provided for building construction and other environments. The hand-held device has a frame supporting an applicator roller rotatably mounted at a forward portion of the frame, and tape spool also is rotatably mounted to the frame to support a roll of the transfer adhesive material and unreel transfer adhesive material to the applicator roll as the applicator roll moves against a substrate with the adhesive layer in contact therewith. A release liner take-up spindle is rotatably mounted to the frame between the tape spool and the applicator roll to take-up the release liner. A drive means interconnects the tape spool and release liner take-up spindle for synchronized rotation, and tape spool retaining means and take-up spindle retaining means restrict rotational speeds thereof to reduce slippage thereof.

### FIELD OF THE INVENTION

This invention relates to devices for applying adhesive tape material to building structures and methods of use thereof.

### BACKGROUND OF THE INVENTION

The roof and wall structures of residential or commercial buildings are typically constructed by attaching several structural panels to the rafters of an underlying supporting structural frame. The panels are most often placed in a quilt-like pattern with the edge of each panel contacting the edges of adjacent panels so as to form a substantially continuous flat surface atop and surrounding the structural frame. In the case of roofs, a water barrier layer, such as felt paper, is then applied over the panels before the installation of shingles, tiles, shakes, or other outer roofing materials. The use of felt paper has many drawbacks including, but not limited to, the extensive labor needed to apply it and its susceptibility to wind damage before the installation of an outer layer of shingles or other roofing material thereon.

Felt paper, typically supplied in roll form, has been applied manually, or using devices such as a so-called roofing machine (e.g., see U.S. Pat. No. 907,731), which usually includes a wheeled frame which is pulled or pushed across the roof by an operator. The frame often carries a roll of felt paper on a storage roller, and a pressure roller rolls along the roof surface and presses the felt web dispensed from the storage roller against the previously laid down roofing layer. Also, a roof surface often is irregular or uneven. Pressure rollers ideally would press against felt paper with uniform pressure along the entire width of the pressure roller while conforming the layer of felt paper to an uneven contour of a roof surface being covered. Roofing machines having frame, support roll, handle, and a deformable pressure roller configuration also have been proposed (e.g., see U.S. Pat. No. 4,460,433). These prior roofing machines are not designed to be handheld during their operation. The need to haul a relatively bulky machine on and off roofs is very inconvenient. Also, bulky roofing machines may not be convenient for use at edges of roofs and/or around upright obstacles commonly encountered on a roof such as chimneys and vent pipes. In addition, roofs having steeper pitch may not be conducive for operation of a roofing machine thereon needing an operator to maintain a generally upright stance. Also, the prior roofing machines generally can not also be used for other significant construction site tasks such as wall construction, and so forth.

Water-resistant seam tape has applied to seams between adjoining roofing or wall panels by bare hand as part of a water-proofing scheme. The process is slow, cumbersome and laborious. A seam tape applicator for applying a seam tape to an edge of a membrane sheet has been described including a frame which can be pushed via handle by an operator without bending over (e.g., see U.S. Pat. Appln. Publ. No. 2004/0129387 A1). The applicator applies a seam tape to a surface in such a way that an upper release liner is not separated from the seam tape until after the tape has already been applied to the lower edge of a seam.

For wall installations in building construction, an extra step must typically be added to the installation process to prevent liquid moisture and air from passing through the wall. Specifically, constructing a wall with a weather barrier requires not only that panels be attached to framing members, but also a house wrap is unrolled and spread over the walls. The house wrap is attached to the sheathing panels with staples or button cap nails and fenestration openings for windows or doors must be cut out of the wrap and the flaps from these openings folded back and stapled down. The house wrap is often difficult to install because it is in typical nine-ft wide rolls, which can be difficult to maneuver by workers on scaffolding or in windy conditions. To help prevent mold growth, a drainage plane is optionally applied. The use of the moisture barrier wrap, or a drainage plane increases cost due to increased material and labor cost.

Handheld tape dispensers and applicators have been in widespread use for many years for relatively light-duty applications. For instance, prior tape dispensers and tape applicators have been used for dispensing adhesive tapes such as masking tapes, packaging tapes, cosmetic tapes, surgical tapes, and electrical tapes, etc. Tape dispensers and applicators have been used to dispense selected lengths of adhesive materials in strip form from a roll of tape. In many instances, the dispensers are used to dispense a single-sided adhesive tape having pressure-sensitive adhesive applied to only one face thereof, which tapes usually can be unreeled from a supply roll and directly applied to a surface without the need for elaborate dispensing devices. However, the use of lined adhesive tapes is desirable in many applications. Prior tape dispensing devices have been described for dispensing a strip of pressure-sensitive adhesive tape supported on a release liner. These tape dispenser devices have included configurations having a take-up spool for collecting release liner, which is driven by the unwinding of tape from a supply spool (e.g., see U.S. Pat. Nos. 3,969,181; 4,570,868; and 4,718,971). Drive mechanisms for such self-driven devices ideally should provide the requisite mechanical functionality without overly burdening the handheld device with additional bulk and weight. Tape dispensing devices fitted with pistol grips have increased balance considerations that ideally should be addressed, as the predominant mass of the dispenser often will be supported above the gripping hand. Meeting all of these concerns can be expected to become even more challenging as size and weight of an adhesive tape roll is increased.

The present investigators have recognized a need for handheld devices suitable for application of adhesive sealing tapes in the construction of roofs, walls, or other building structures. As will become apparent from the descriptions that follow, the inventive device and methods of its use addresses these needs as well as providing other advantages and benefits.

### SUMMARY OF THE INVENTION

The invention provides a hand-held adhesive tape applicator adapted for single-handed operation in building construction and other environments. The device is operable to apply an adhesive tape material to a substrate surface, such as a transfer adhesive tape material comprising an adhesive layer carried on a release liner, or alternatively a non-backed single-sided adhesive tape material. The hand grippable device is operable to dispense adhesive layers supplied from relatively large diameter and heavy tape rolls stored aboard the device onto uneven substrate surfaces.

In one embodiment, a hand-held device is provided for applying an adhesive tape material to a building structure, in which the device has a frame which supports adhesive tape material handling and dispensing components, including an applicator roller rotatably mounted at a forward portion of the frame which is adapted to press adhesive tape material against a substrate such as building structure. A tape spool also is rotatably mounted to the frame, which is adapted to i) support a roll of the transfer adhesive material, and ii) unreel transfer adhesive material to the applicator roll as the applicator roll moves against a building structure with the adhesive layer in contact therewith. A release liner take-up spindle is rotatably mounted to the frame at a position between the tape spool and the applicator roll, which is adapted to take-up the release liner after the adhesive layer is transferred therefrom to a building structure. A drive means drivingly interconnects the tape spool and release liner take-up spindle, which is adapted to wind the release liner upon the take-up spindle at a speed which is the same or greater than a speed at which the transfer adhesive tape material is unreeled from the tape spool. A first clutch means is included in the tape spool operable to restrict the rotational speed thereof. A second clutch means is included in the take-up spindle operable to restrict the rotational speed thereof. A hand grip mounted to a base portion of said frame which is operable to permit the device to be held by a single hand of an operator. In one embodiment, the hand grip is attached to the base portion of the frame at a position such that the center of gravity of the device with a mounted tape roll is over the center of an operator's wrist. The hand grip may include grip-enhancing means, e.g. ribbing, aiding in preventing slippage such as when the handle grip is damp.

In one particular embodiment, the drive means comprises a gear train wherein the rotation of the tape spool is transmitted to the take-up spindle, and wherein the gear train comprises a first gear receiving force transmitted from rotation of the supply spool and a second gear receiving the force and transmitting it to rotate the take-up spindle, and including at least two idler gears which are drivingly interconnected between the first and second gears to transmit the force therebetween. This arrangement allows angular rotational speed of the release liner take-up spindle to be automatically synchronized with angular rotation speed of said tape spool retainer by the drive means. In a more particular embodiment, the gear train gears are rotatably mounted in respective recesses provided in the frame. The provision of an even number of idler gears also allows the rotational direction of the supply spool to be reversed as transmitted through the gear train to the take-up spindle so that it can automatically wind-up liner as the supply spool unreels fresh tape. The idler gears also provide clearance on the frame between the supply spool and the take-up spindle.

In another particular embodiment, the first clutch means includes a first friction plate urged into contact with the first gear via spring biasing means. More particularly, the first clutch means includes a first friction plate and adjoining first felt friction disk urged into such contact. The first clutch is operable to dissipate excess speed of rotation of the tape spool to reduce or prevent overstretching of the tape, and it also reduces or prevents self-tightening and tape spool slippage. In this embodiment, the second clutch means includes a second friction plate urged into contact with the second gear via spring biasing means. The second clutch means in the take-up spindle allows the take-up spindle to slip so that it can move at the same angular speed as the tape spool while also being operable to dissipate excess speed of rotation of the take-up spindle to reduce or prevent overstretching of the liner and/or slippage of the take-up spindle in a rotational direction opposite to the wind-up direction which might lead to slack in the spent liner during tape application.

In another embodiment, the device frame comprises a unitary generally plate-like (planar) structure having a first frame part onto which the gear train is mounted wherein the respective axes of rotation of the first, second and idler gears is generally axially aligned, and a second frame part extends in a tilted direction from the first frame part and the applicator roll is mounted on the second frame part, wherein the applicator roll has an axis of rotation positioned about 12 to about 18 degrees, and particularly about 14 to about 16 degrees, measured between a first line intersecting the axes of rotation of the gear train and a second line intersecting the axis of rotation of the take-up spindle gear and the applicator roll axis of rotation. In this tilted frame configuration, the spent liner on the take-up spindle more easily can clear the path of a transfer adhesive tape as it travels from the supply roll up over the take-up spindle and under the applicator roll. It also takes less effort to apply the adhesive tape throughout the life of the roll, and it makes it easier to apply pressure to the tape as it is being applied, and it allows for easier, more precise cutting of the tape.

In another embodiment, the device applicator roll is comprised of a relatively hard yet resilient material having a Durometer hardness between about 15 to about 90. For a more textured substrate surface, the Durometer hardness of the applicator roll may range from about 15 to about 60, particularly between about 20 and about 50. For a smoother substrate surface, the Durometer hardness of the applicator roll may range from about 20 to about 90, particularly between about 40 and about 85. A device applicator roller having the indicated hardness has sufficient flexibility and resiliency to allow an adhesive tape to better accommodate the topography of a substrate, especially uneven or textured surfaces. The adhesive tape thus can be applied in a manner making a water-resistant seal on uneven surfaces, such as gaps between structural components, with one pass of the applicator device. The applicator roller also is firm enough to maintain enough nip pressure on the adhesive tape to provide generally continuous secure bonding contact between the strip of adhesive tape and a substrate surface, especially an uneven, textured substrate surface. The balance of resiliency and hardness provided in the pressure roller is important for providing a tight seal with a seam tape delivered by the applicator device onto a gap present between adjacent structural components, even if other structural features may be present in the tape delivery path which also introduce surface unevenness, i.e., roofing nails, metal joints, flashing, and so forth.

In another embodiment, the device further comprises a hook mounted on a side of the frame opposite to the drive means, which is adapted to allow the device to be releasably supported upon a belt, such as a tool belt, worn by a person.

A roll of adhesive tape is mounted on and dispensed from the applicator device. The adhesive tape may be a transfer adhesive tape material comprising an adhesive layer or film carried on at least one side of a releasable backing or liner. The adhesive layer may be a single-side adhesive tape or double-sided adhesive tape. The device also may be used to apply non-backed single-sided adhesive tapes. The device is adapted to store, handle and apply relatively hefty spools of adhesive tapes. These adhesive tapes include, for example, a roll of transfer adhesive tape material wound on a core part thereof which is mounted on the supply spool, wherein the tape adhesive material has a width of 2 to 8 inches and has a diameter of 3 to 10 inches, and an initial roll weight of up to about 20 pounds, particularly from about 2 to about 10 pounds. The applicator device of embodiments herein can accommodate a relatively large diameter roll of adhesive tape, which reduces the frequency of tape roll changes needed. In a particular embodiment, the transfer adhesive tape material comprises an adhesive layer comprising a moisture-resistant pressure-sensitive adhesive film carried on a face of a removable liner. In the instance of applying lined adhesive tapes with the applicator device, the take-up spindle of the device also is adapted to allow easy removal of a spent liner rolled thereon, wherein the spindle comprising a plurality spaced apart posts protruding from an integral common base allowing spent liner wrapped thereon to be gripped on opposite exposed sides of the roll and pulled off the spindle posts. In one embodiment, to provide linear speed parity for an initial circumference of an about 7 to about 8 inch diameter tape roll mounted at the supply spool and an initial spent liner circumference on the take-up spindle having a diameter of about 2.5 to about 3.0 inch, the device incorporates a gear train providing an initial mechanical ratio of about 2.5 to about 3.5 between the tape spool and take-up spindle.

The handheld adhesive tape applying device of embodiments of the present invention is suitable for relatively heavy-duty applications such as building construction. For instance, the device is suitable for use in the construction of building structures, especially where it is desirable or useful to cover and seal gaps between abutting roofing panels, abutting wall panels, a window installation in a wall frame, a door installation in a wall frame, a plumbing vent installation in a roof, a skylight installation in a roof, a dormer in a roof, and so forth, with a moisture-resistant seam tape.

In one embodiment, there is a method of installing roofs using water-resistant panels arranged in an abutting configuration, and the hand-held tape applicator device of embodiments of the present invention is used to apply a water-resistant transfer adhesive seam tape to cover and seal the gaps between the abutting panels, followed by attaching an outer roofing coverage (e.g., shingles, shakes, slate, and metal, etc.) without the need to include the typical prior step of applying felt paper. In another embodiment, there is a method of installing walls using water-resistant panels arranged in an abutting configuration, and the hand-held tape applicator device of embodiments of the present invention is used to apply a water-resistant transfer adhesive seam tape to cover and seal the gaps between the abutting panels, followed by completing the wall construction (e.g., adding siding, etc.) without the need to include the typical prior step of applying a water-proofing house wrap.

### BRIEF DESCRIPTION OF THE DRAWINGS

FIG. 1 is a perspective view of a device for applying adhesive tape to a building structure or other substrate, including a partial cut-away view of a tape cutting and tape spool core retainer thereof, according to an embodiment of the invention.

FIG. 2 is a side elevational view of the device of FIG. 1 with a roll of tape mounted on the supply spool showing travel paths of a transfer adhesive tape material and an adhesive layer and a liner thereof during tape application on a substrate surface.

FIG. 3 is an exploded perspective view of the device according to FIG. 1.

FIG. 4 is a side elevational view of the device of FIG. 1 with a take-up spindle body removed and without a roll of tape mounted on the supply spool to show a gear train feature of the device.

FIG. 5 is an enlarged cross-sectional view of the supply spool and take-up spindle of the device of FIG. 1 including respective clutch means incorporated therein.

FIG. 6 is an enlarged perspective view of a take-up spindle assembly of the device according to FIG. 1.

FIG. 7 is an enlarged perspective view of an alternative take-up spindle assembly of the device of FIG. 1.

FIG. 8 is an enlarged perspective view of an alternative take-up spindle assembly of the device of FIG. 1.

FIG. 9 is an enlarged perspective view of an alternative take-up spindle assembly of the device of FIG. 1.

FIG. 10 is a perspective view including a partial cut-way view of the outer roofing coverage to show an underlying assembly of roofing structural panels having a moisture-resistant seam tape applied to gaps at abutting side edges thereof which has been applied with a device according to FIG. 1.

FIG. 11 is a perspective view including a partial cut-way view of the outer wall coverage to show an assembly of wall structural panels behind thereof having a moisture-resistant seam tape applied to gaps at abutting side edges thereof which has been applied with a device according to FIG. 1.

The figures and elements therein are not necessarily drawn to scale. Similarly numbered elements in different figures represent like features unless indicated otherwise.

### DETAILED DESCRIPTION OF THE PREFERRED EMBODIMENTS

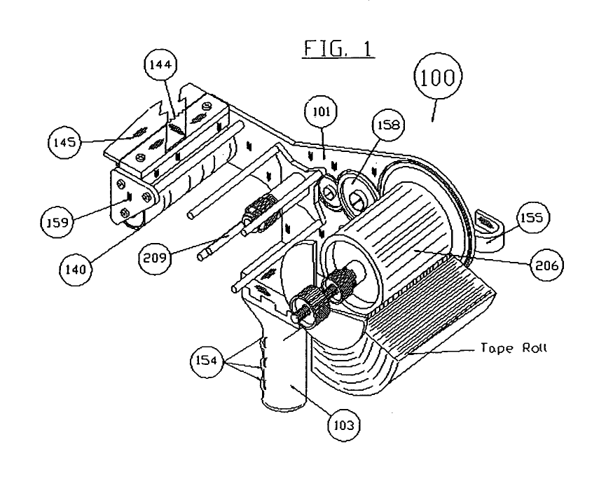

Preferred embodiments of the invention are described below by referring to the drawings. Referring to FIG. 1, a hand-grippable adhesive tape applicator device 100 is shown which is suitable for single-handed operation in building construction and other environments. The device 100 includes, e.g., a tape spool 206 and a take-up spindle 209 and a drive means 158 operable between them. An applicator 140 is provided at a forward position 159 of the device 100, and a tape cutting member and pivotal cutting member guard 145 are provided above the applicator roll 140. Building construction work, for example, is often carried out under less than ideal weather conditions such as high and low temperatures, high humidity, etc. All of these factors tend to introduce moisture to the hand and makes gripping difficult.

As illustrated in FIG. 1, the handle or hand grip 103 of tape applicator device 100 has a profile which varies along its length to accommodate to the palm of the user. The central portion of the handle should fit into the hollow of the user's palm. The handle may be more bulbous in the central portion of the handle. The presence of the elastomeric coverage can be included to provide an easy grip. By way of example, not limitation, one exemplary such elastomeric material is a thermoplastic rubber compound, for example, NAFLEX® G-6713-0001 sold by GLS Corporation, Thermoplastic Elastomeric Division, Cary, Ill., U.S.A. The preferred Durometer hardness is between 10 and 30 Shore A, with the most preferred being 25 Shore A. As shown, the handle 103 also may be provided with ribbing 154 to increase non-slip grippability for ease of operation under damp conditions. For instance, the handle 103 may be constructed as a hard plastic base having a thin layer of ribbed elastomeric coverage not exceeding about 3 mm in thickness.

Also, construction workers typically are required to climb around the building frame during their work. Thus it is desirable to allow ease of carrying of their tools to free up their hands for safety in climbing. The applicator device 100 of the present invention also may include an attachment means 155, e.g., a hook integrally attached to the side of the device frame 101 opposite to the tape handling and dispensing means, to allow a worker to conveniently carry the tape applicator on the worker's tool belt.

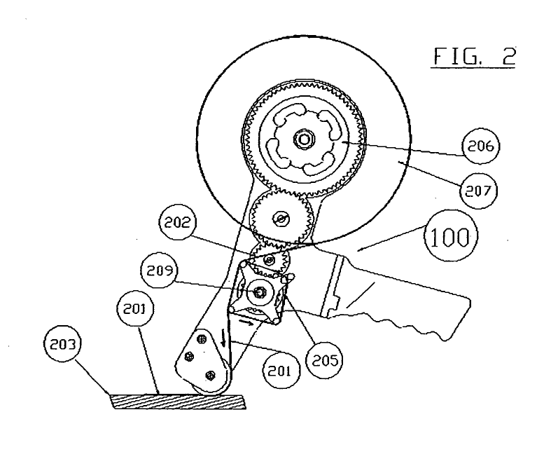

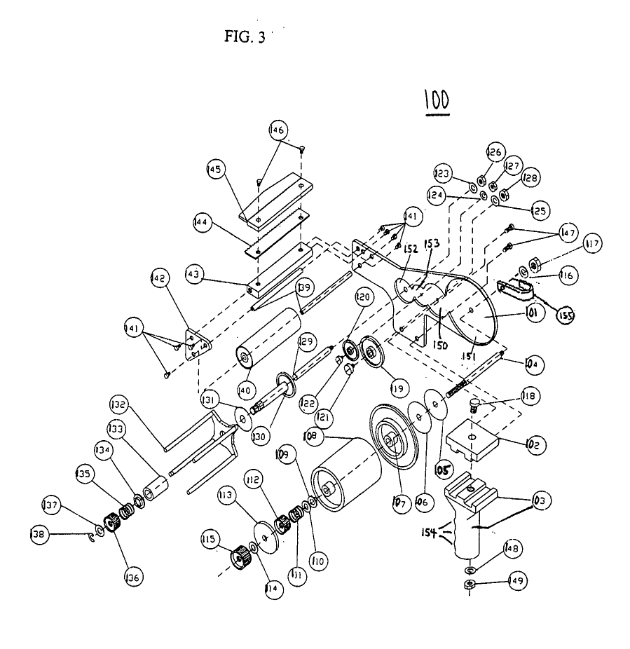

As illustrated in FIG. 2, the device 100 is operable in manner that allows an adhesive layer 201 of a transfer adhesive material 202 to be transferred onto a substrate surface 203 while a protective release liner 205, which separates successive wound layers of adhesive layer on the wound supply roll of tape 207 mounted on tape spool 206, is collected around take-up spindle 209. The tape 207 generally may be a conventional configuration with a strip of adhesive material successively wrapped around a hollow circular core adapted to be releasably fitted upon tape spool 206. The device 100 also may be used apply non-backed single-sided adhesive tape material to a substrate, wherein there is no need use take-up spindle 209 to collect spent liner. As adhesive tape is applied and stuck to surface 203 as applicator device 100 is pulled across the surface 203, tension is created in transfer adhesive tape 202 creating a torque force on supply spool 206, causing it to rotate and unreel more tape. Rotation of tape spool 206, in turn, causes rotation of take-up spindle 209 so that it can simultaneously and automatically collect more spent liner via a drive means which is described in greater detail below with reference to FIGS. 3-5. The effective outer diameters of the supply tape spool 206 and the take-up spindle 209 are constantly changing as the adhesive tape 202 is unwound from a tape roll 207 mounted for rotation on tape spool 206 and the spent release liner 205 is collected on the take-up spindle 209. For instance, in a tape applying operation such as for building construction, the effective diameter at the tape spool 206 is relatively large initially and progressively decreases as supply tape is paid out during tape application using device 100 while the spent liner wraps around and accumulates on the tape spindle 209 such that its effective diameter progressively increases. The ideal mechanical drive ratio needed between the tape spool 206 and take-up spindle 209 thus generally will vary as the effective sizes of the rolls on the spool and spindle varies during a tape dispensing operation using applicator device 100.

Referring to FIG. 3, an exemplary illustration of device 100 is shown with various elements and components thereof including the following: 101: Side frame; 102: Handle Plate; 103: Handle; 104: Tape spool shaft; 105: Felt friction disk; 106: Steel friction plate; 107: Tape spool gear; 108: Tape core mandrel; 109: Engagement washer; 110: Anti-slip washer; 111: Tape spool tension spring; 112: Tape spool tension knob; 113: Tape spool core retainer; 114: Tape spool anti-slip washer; 115: Tape spool retainer knob; 116: Lock washer; 117: Tape spool shaft nut; 118: Handle bolt; 119: Large idler gear; 120: Small idler gear; 121: Large idler gear hub shaft; 122: Small idler gear hub shaft; 123: Take-up spindle flat washer; 124: Small idler gear shaft flat washer; 125: Larger idler gear shaft flat washer; 126: Take-up spindle shaft nut; 127: Small idler gear shaft nut; 128: Larger idler gear shaft nut; 129: Take-up spindle shaft; 130: Take-up spindle gear; 131: Take-up spindle friction plate; 132: Take-up spindle body; 133: Take-up spindle spacer; 134: Take-up spindle hub washer; 135: Take-up spindle tension spring; 136: Take-up spindle tension adjustment knob; 137: Take-up spindle keeper washer; 138: Take-up spindle retaining clip; 139: Steel shaft; 140: applicator roller; 141: Machine screw; 142: Support plate; 143: Knife block; 144: Knife; 145: Knife guard; 146: Bolts; 147: Bolts; 148: Washer; 149: Nut; 150: frame recess for idler gear 119; 151: frame recess for drive gear 107; 152: frame recess for take-up spindle gear 130; 153: frame recess for idler gear 120; 154: ribbing; and 155: hook.

It will be understood that the elements and their manners of assembly in device 100 as illustrated in FIG. 3 are exemplary and non-limiting. Some of the illustrated components, such as fasteners and washers, etc., have some practical significance but are not themselves critical to the invention and are included merely to further clarify the illustration.

Still referring to FIG. 3, the side frame 101 is unitary and relatively rigid part. Frame 101 may be, for example, a cast or stamped metal part, or a shaped or molded composite material or ceramic material, etc. For instance, the device 100 may be a cast aluminum or steel frame plate, used together with plastic rollers, tape wells, and gears. As also can be seen in FIG. 3, the integral circular recesses 150 to 153 provided for rotatably mounting the respective drive gears within the side frame 101 are axially aligned with respect to their centers, and open into each other at their axial (lateral) sides such that the gears can be intermeshed at those locations while still being retained within the respective frame recesses. The hand grip 103 mounted to a base portion 102 of the frame 101 is operable to allow the device 101 to be held by a single hand of an operator. In one embodiment, the hand grip 103 is attached to the base portion 102 of the frame 101 at a position such that the center of gravity of the device 101 with a mounted tape roll is over the center of an operator's wrist. For instance, as indicated by the view of FIG. 1, the base portion 102 stands off the side frame 101 (i.e., towards the viewer in this perspective) at a generally perpendicular angle and supports the hand grip 103 directly underneath. Even if a relatively wide tape roll is mounted on tape spool 206, the center of gravity of the device 100 generally still remains over the center of gravity of an operator's wrist, providing enhanced ergonomics and ease of operation.

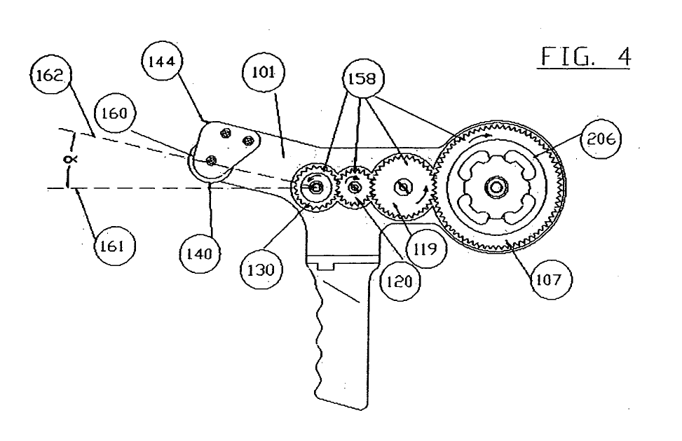

Referring to FIG. 4, the gears 107, 119, 120 and 130 are illustrated in this example as comprising gear wheels having gear teeth extending around their circumferences. The gears are rotatably seated in their respective recesses provided the side frame 101 such that gear teeth of adjacent gears intermesh. As shown by the indicated directional arrows, rotation of the supply spool 206 causes rotation of its associated drive gear 107 which in turn rotates the take-up spindle gear 130 through the drive means 158. The two intervening idler gears 119 and 120 transmit the rotational force of the tape spool drive gear 107 to the take-up spindle gear 130. Although not required, the provision of an even number of idler gears (e.g., 2, 4, 6, etc.) allows the rotational direction of the supply spool 206 to be reversed as transmitted through the gear train to the take-up spindle 209 so that it can automatically wind-up liner as the supply spool unreels fresh tape. The idler gears also help provide clearance on the frame between the supply spool and the take-up spindle. The drive means 158 provided in device 100 allows the angular rotational speed of the release liner take-up spindle 209 to be automatically synchronized with angular rotation speed of said tape spool 206. The drive gear 107 is larger than the driven gear 130 providing a mechanical transmission ratio such that the take-up spindle is rotated at an angular speed as fast as, and preferably faster than, that of the supply spool 206, so that occurrence of slack in the tape is reduced or prevented. Consequently, the adhesive tape and release liner remain taut and generally slack-free, but are not stretched to the point of rupture, as they are respectively unwound and/or rewound by applicator device 100.

The applicator roller 140 has an axis (center) of rotation 160 positioned an angle α of about 12 to about 18 degrees, and particularly about 14 to about 16 degrees, measured between a line 161 intersecting the axes of rotation of the gear train 158 and a line 162 intersecting the axis of rotation of the take-up spindle gear 130 and the applicator roll axis of rotation 160. In this tilted frame configuration, the path of a transfer adhesive tape as it travels from the supply roll up over the take-up spindle and under the applicator roll can more easily clear the spent liner being wound on the take-up spindle. It also takes less effort to apply the adhesive tape throughout the life of the roll, and it makes it easier to apply pressure to the tape as it is being applied, and it allows for easier, more precise cutting of the tape. This also makes it easier for an operator to use the tape applicator device 100 on angled surfaces and with larger rolls of tape. Also, by offsetting the applicator roll 140 off the main axis of the supply spool and take-up spindle, the cutter 144 can be positioned for more precise cutting and reduced damage to substrate surfaces during tape application.

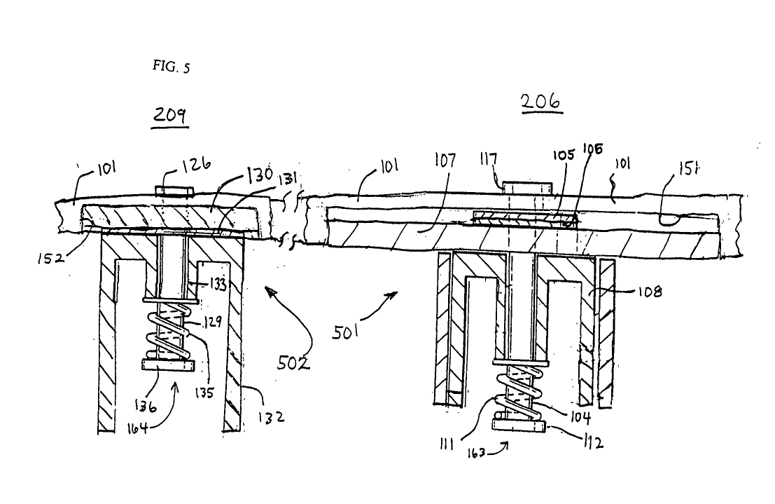

Referring to FIG. 5, a first clutch means 501 is shown that is included in the tape spool 206 operable to restrict the rotational speed thereof. A second clutch means 502 is shown that is included in the take-up spindle 209 operable to restrict the rotational speed thereof and allow slip. As indicated, the effective outer diameters of the supply tape spool 206 and the take-up spindle 209 constantly change as the adhesive tape 202 is unwound from a tape roll 207 mounted for rotation on tape spool 206 and the spent release liner 205 is collected on the take-up spindle 209. In general, the tape spool gear 107 is sized larger in diameter than the spindle gear 130 sufficient to provide a mechanical drive ratio between the tape spool 206 and take-up spindle 209 which will ensure that the take-up spindle 209 is rotated at an angular speed which is the same or greater than that of the tape spool 206 for all effective diameters of tape rolls and wound spent liner on device 100 during a tape application run or runs using a given tape roll. In this manner, the adhesive tape and liner are kept taut and generally slack-free, but are not over-tensioned or over-tightened.

Still referring to FIG. 5, clutch means 501 includes a felt friction plate 105 and an adjacent steel friction plate 106 urged into contact with tape spool gear 107 via spring biasing means 163 comprising helical spring 111 arranged on the tape spool shaft 104 rigidly attached to the backside of the frame 101 via lock washer 117. The spring 111 is held in compression against the tape core mandrel 108 via tension adjustment knob 112, which in turn urges the gear 107 against friction plate 106. The first clutch 501 is operable to dissipate excess speed of rotation of the tape spool to reduce or prevent overstretching of the tape, and it also reduces or prevents self-tightening and tape spool slippage. Clutch means 502 includes a friction plate 131 urged into contact with take-up spindle gear 107 via spring biasing means 164 comprising helical spring 135 arranged on the spindle shaft 129 rigidly attached to the backside of the frame 101 via lock washer 126. The spring 135 is held in compression against the take-up spindle spacer 133 of the spindle body 132 via tension adjustment knob 136, which in turn urges the friction plate 131 against gear 130, which effectively restricts the rotational speed of the gear but also allows for slip. The second clutch means 502 in the take-up spindle allows the take-up spindle to slip so that it can move at the same angular speed as the tape spool while also being operable to dissipate excess speed of rotation of the take-up spindle to reduce or prevent overstretching of the liner and/or slippage of the take-up spindle in a rotational direction opposite to the wind-up direction which might lead to slack in the spent liner during tape application.

In another embodiment, the applicator roll 140 (e.g., see FIGS. 1 and 4) of the applicator device 100 is comprised of a relatively hard yet resilient material having a Durometer hardness of between about 15 to about 90. For a more textured substrate surface, the Durometer hardness of the applicator roll may range from about 15 to about 60, particularly between about 20 and about 50. For a smoother substrate surface, the Durometer hardness of the applicator roll may range from about 20 to about 90, particularly between about 40 and about 85. A device applicator roller having the indicated hardness has sufficient flexibility and resiliency to allow an adhesive tape to better accommodate the topography of a substrate, especially uneven or textured surfaces. The adhesive tape thus can be applied in a manner making a water-resistant seal on uneven surfaces, such as gaps between structural components, with one pass of the applicator device. For example, the pressure applicator roller has a relatively low Durometer softness but is sufficiently deformable in order to press a tape into crevices that are present on uneven surfaces, such as panels made of oriented strand board. The applicator roller also is firm enough to maintain enough nip pressure on the adhesive tape to provide generally continuous secure bonding contact between the strip of adhesive tape and a substrate surface, especially an uneven, textured substrate surface. The balance of resiliency and hardness provided in the pressure roller is important for providing a tight seal with a seam tape delivered by the applicator device onto a gap present between adjacent structural components, even if other structural features may be present in the tape delivery path which also introduce surface unevenness, i.e., roofing nails, metal joints, flashing, and so forth. For purposes herein, “Durometer hardness” refers to Shore A hardness unless indicated otherwise. The Shore hardness is measured using the ASTM test method designated ASTM D2240 00. The Durometer hardness values obtained from this test method are a useful measure of relative resistance to indentation of various grades of polymers.

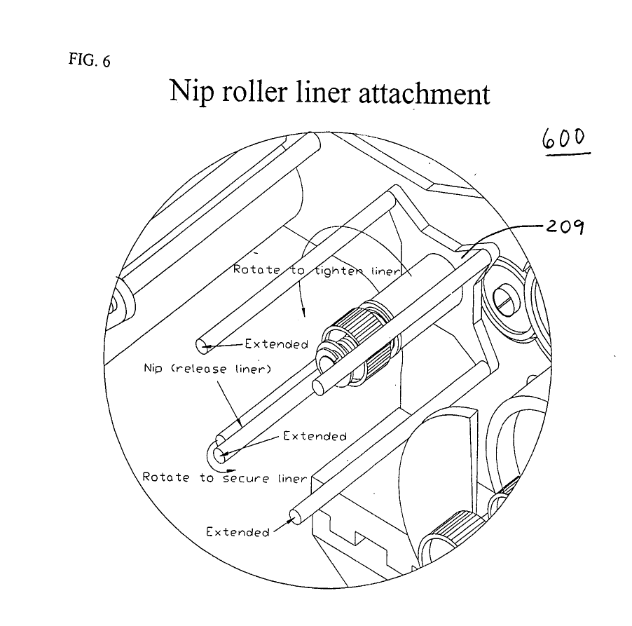

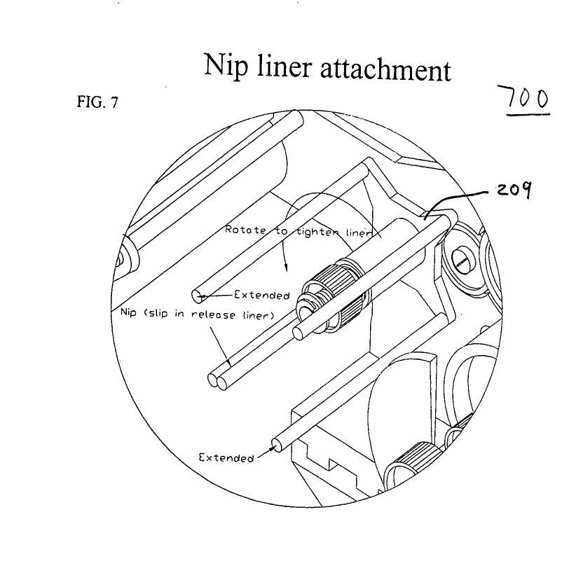

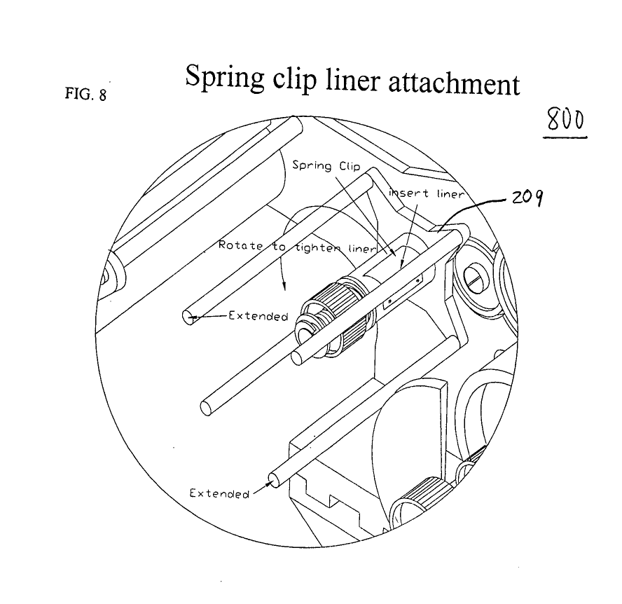

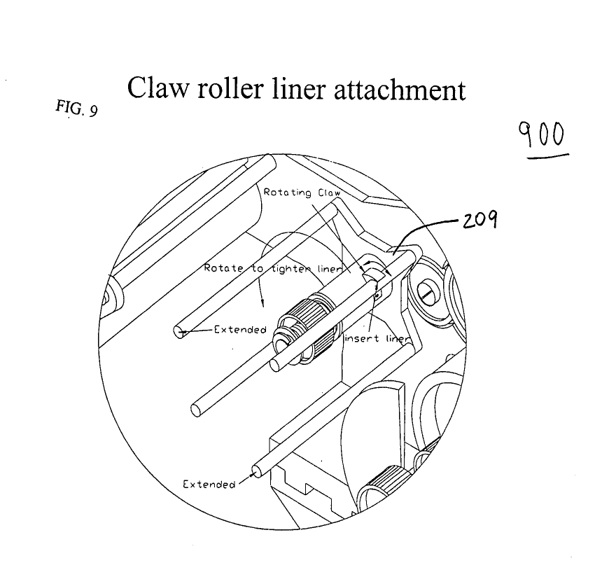

Referring to FIGS. 6-9, several alternative take-up spindle arrangements are illustrated for releasably securing the release liner so that it can be wind-up on the take-up spindle under suitable tension and avoid slack therein. In FIG. 6, in arrangement 600 the take-up spindle assembly 209 includes a nip which is provided between a pair of posts extending upright from the base of the spindle through which a leading edge of a liner can be inserted and wrapped around as indicated to wrap enough liner around the two adjoining posts to allow further spent liner collection to proceed around the spindle posts in a secure automated manner under adequate tension as the applicator device is operated. This release liner take-up spindle arrangement provides for easier removal of the liner, as the two “nip rollers” or posts are incorporated into the take-up spindle for ease of loading and tightening of release liner to the spindle. In arrangement 700 shown in FIG. 7 a modified version of the take-up spindle 209 is illustrated in which a pair of adjoining posts include a nip for receiving a leading edge of the liner and then the entire spindle can be rotated sufficient to wrap enough liner around the spindle posts to allow further spent liner collection to proceed in a secure automated manner under adequate tension as the applicator device is operated. In arrangement 800 shown in FIG. 8 the take-up spindle 209 includes a spring clip for receiving and holding the leading edge of the release liner. In arrangement 900 shown in FIG. 9 the take-up spindle 209 includes a rotatable claw for receiving and grasping the leading edge of the release liner. These examples of liner retention means are illustrative and non-limiting.

The handheld tape applicator 100 can handle relatively large tape widths, such as up to about 8 inches or even more, depending on the scale of the assembled device and weight of the tape roll carried thereon. The applicator device 100 of embodiments herein similarly can accommodate a relatively large diameter roll of adhesive tape having a large strip length, which reduces the frequency of tape roll changes needed.

Before initiating a tape application operation with device 100, a roll of adhesive tape 207 is mounted on the tape spool 206 of device 100 (e.g., see FIG. 2). The adhesive tape may be a transfer adhesive tape material comprising an adhesive layer or film (e.g., a moisture-resistant single-sided pressure-sensitive adhesive film) carried on a releasable backing or liner. The release liner may have a thickness of about ½ to about 1/30 the thickness of the adhesive layer. Optionally, the tape may have a backing of a thickness of about 1.0 mils to about 15 mils and an adhesive layer disposed on the backing of a thickness of about 2.0 mils to about 30.0 mils. The dry coefficient of friction for the tape is preferably at least about 0.6. Alternatively, the device 100 may be used to apply non-backed single-sided adhesive tapes. The device 100 is adapted to store, handle and apply relatively hefty spools of adhesive tapes. These adhesive tapes include, for example, a roll of transfer adhesive tape material wound on a core part thereof which is mounted on the supply spool, wherein the tape adhesive material has a width of 2 to 8 inches and has a diameter of 3 to 10 inches, and an initial roll weight of up to about 20 pounds, particularly about 2 to about 10 pounds.

In one embodiment, to provide linear speed parity for the initial circumference of an about 7 to about 8 inch diameter tape roll mounted at the supply spool 206 and an initial spent liner circumference on the take-up spindle 209 having a diameter of about 2.5 to about 3.0 inch, the device 100 incorporates a gear train 158 providing an initial mechanical ratio of about 2.5 to about 3.5 between the tape spool 206 and take-up spindle 209.

To operate the tape applicator 100, an operator loads the tape onto the tape core mandrel with the tape unwinding in the clockwise direction. Then the release liner is fed into the take-up spool using the nip rollers for securing the tape; using the nip rollers, tighten the release liner around the take-up spool. To operate, the operator simply places the tape in the desired location and pulls the applicator towards himself/herself while applying pressure to the pressure applicator roller to “seat” the tape. Once the tape is installed, the operator can cut the tape using the serrated knife located above the pressure applicator roller. This operation is repeated until all of the seams are covered.

In this general manner, the handheld applicator device 100 may be used in such a manner to apply strips of moisture-resistant seam tape to seal gaps or crevices associated with a building structure, such as abutting roofing panels, abutting wall panels, a window installation in a wall frame, a door installation in a wall frame, a plumbing vent installation in a roof, a skylight installation in a roof, and a dormer in a roof. The applicator device 100 makes it possible to apply seam, ridge and valley tape in building constructions applications with a handheld device instead of installing the tape by hand. This speeds up the construction process and avoids unwound release paper collecting around the work surface.

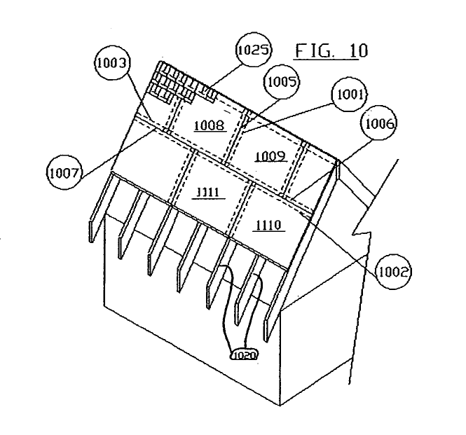

Referring to FIG. 10, the handheld applicator device 100 may be used to apply strips of moisture-resistant seam tape 1001, 1002, 1003, etc. (indicated in hatched lines) to cover gaps 1005, 1006, 1007, etc., between adjacent structural panels 1008, 1009, 1010, 1011, etc., applied to a roof surface or frame 1020 before outer roofing coverage 1025 (e.g., shingles, shakes, slate, and metal) is applied thereover. The adjacent structural panels may have an integral water-resistant layer or coating on one or both major faces thereof. The seam tape protects the abutting edges of the adjacent panels. This method of applying seam tape with device 100 eliminates the need for the installation of felt paper or tar paper for roof construction.

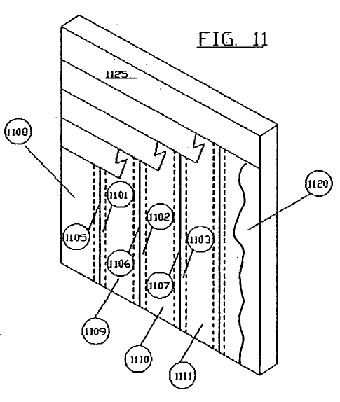

Referring to FIG. 11, the handheld applicator device 100 also may be used to apply strips of moisture-resistant seam tape 1101, 1102, 1103, etc. (indicated in hatched lines) to cover gaps 1105, 1106, 1107, etc., between adjacent structural panels 1108, 1109, 1110, 1111, etc., applied to a wall surface or frame 1120 before outer wall coverage 1125 (e.g., siding) is applied thereover. The adjacent structural panels may have an integral water-resistant layer or coating on one or both major faces thereof. The seam tape again protects the abutting edges of the adjacent panels. This method of applying seam tape with device 100 eliminates the need for installing additional water impermeable membrane or other wall wraps for wall construction. The applicator 100 may also be used, for example, for the application of window flashing tape up to four inches in width with an outside diameter no greater than 7.75 inches.

The roll of adhesive tape used needs to be wide enough to cover and seal the seams or gaps formed between abutting panels in such building construction applications, but not too wide to hinder application. It generally may be about 2 inches or wider, but typically not wider than 36 inches, with 2 to 8 inches being a preferred range for many applications. For wider tapes, a “push” application method may be better than a pull application method. Two examples of water-resistant seam tape which may be used are PROGRIP 6038 tape made by 3M, St. Paul Minn., and B14 tape made by Tyco International.

As can be appreciated, the tape applying device of embodiments of the present invention provides, among other benefits and advantages, single-handed grip operation; one pass application; reduced tape spool slippage; reliable synchronized collection of liner during tape application; reduced tape spool self-tightening during dispensing to prevent over-stretching of tape; and reduced grip slippage when wet; ease of carrying on a tool belt; ease of tape exchange; and ease of spent liner removal.

While the invention has been particularly described with specific reference to particular process and product embodiments, it will be appreciated that various alterations, modifications and adaptations may be based on the present disclosure, and are intended to be within the spirit and scope of the present invention as defined by the following claims.

What is claimed is:

1. A hand-held device for applying an adhesive tape material to a substrate, comprising:
a frame;
an applicator roller rotatably mounted at a forward portion of said frame, adapted to press transfer adhesive tape material comprising an adhesive layer carried on a release liner against a substrate;
a tape spool rotatably mounted to said frame, adapted to i) support a roll of the transfer adhesive material, and ii) unreel transfer adhesive material to the applicator roll as the applicator roll moves against a substrate with the adhesive layer in contact therewith, and including first clutch means operable to restrict the rotational speed thereof;
a release liner take-up spindle rotatably mounted to said frame at a position between the tape spool and the applicator roll, adapted to take-up the release liner after the adhesive layer is transferred therefrom to a substrate, and including second clutch means operable to restrict the rotational speed thereof;
drive means drivingly connecting the tape spool and release liner take-up spindle, adapted to wind the release liner upon the take-up spindle at a speed as great as a speed at which the transfer adhesive tape material is unreeled from the tape spool; and
a hand grip mounted to a base portion of said frame.

2. The device of claim 1, wherein the drive means comprises a gear train wherein the rotation of the tape spool is transmitted to the take-up spindle, and wherein the gear train comprises a first gear receiving force transmitted from rotation of the supply spool and a second gear receiving the force and transmitting it to rotate the take-up spindle, and including at least two idler gears which are drivingly interconnected between the first and second gears to transmit the force therebetween.

3. The device of claim 2, wherein the first clutch means includes a first friction plate urged into contact with the first gear via spring biasing means, operable to dissipate excess speed of rotation of the tape spool; and the second clutch means includes a second friction plate urged into contact with the second gear via spring biasing means, operable to dissipate excess speed of rotation of the take-up spindle.

4. The device of claim 1, wherein the applicator roller has a Durometer softness index value of about 15 to about 90.

5. The device of claim 1, where angular rotational speed of said release liner take-up spindle is synchronized with angular rotation speed of said tape spool retainer by the drive means comprising a series of drivingly interconnected gears mounted in respective recesses in the frame.

6. The device of claim 1, wherein the release liner take-up spindle retaining means is operable to prevent slippage of the release liner during application of the adhesive tape material to a substrate.

7. The device of claim 1, wherein the tape spool retainer means is operable to prevent self-tightening and tape spool slippage during application of the adhesive tape material to a substrate.

8. The device of claim 2, wherein the frame further comprises a first frame part onto which the gear train is mounted wherein the respective axes of rotation of the first, second and idler gears is generally axially aligned, and a second frame part extending in a tilted direction from the first frame part and the applicator roll is mounted on the second frame part, wherein the applicator roll has an axis of rotation positioned about 12 to about 18 degrees measured between a first line intersecting the axes of rotation of the gear train and a second line intersecting the axis of rotation of the take-up spindle gear and the applicator roll axis of rotation.

9. The device of claim 2, wherein the gear train provides an initial mechanical ratio of about 2.5 to about 3.5 between the tape spool and take-up spindle.

10. The device of claim 1, wherein the said handle contains grip enhancing means aiding in preventing slippage when damp.

11. The device of claim 1, further comprising a hook mounted on a side of the frame opposite to the drive means, adapted to allow the device to be releasably supported upon a belt worn by a person.

12. The device of claim 1, wherein the device further includes a roll of transfer adhesive tape material mounted on the supply spool, wherein the tape adhesive material has a width of 2 to 8 inches and has a diameter of 3 to 10 inches, and an initial roll weight of about 2 to about 10 pounds.

13. The device of claim 11, wherein the transfer adhesive tape material comprises an adhesive layer comprising a moisture-resistant single-sided pressure-sensitive adhesive film carried by a liner.

14. The device of claim 1, further comprising a serrated cutter mounted on the said frame at a position adjacent and forward of said applicator roller.

15. A method of constructing a roof, comprising:
(A) providing a roofing frame;
(B) fastening a plurality of structural panels having an integral moisture barrier in an abutting arrangement onto the roofing frame with fastening means;
(C) covering a gap formed between the abutting structural panels with a water-resistant seam tape using a handheld device, wherein the handheld device comprises:
a frame,
an applicator roller rotatably mounted at a forward portion of said frame, adapted to press transfer adhesive tape material comprising an adhesive layer carried on a release liner against a building structure,
a tape spool rotatably mounted to said frame, adapted to i) support a roll of the transfer adhesive material, and ii) unreel transfer adhesive material to the applicator roll as the applicator roll moves against a building structure with the adhesive layer in contact therewith, and including first clutch means operable to restrict the rotational speed thereof,
a release liner take-up spindle rotatably mounted to said frame at a position between the tape spool and the applicator roll, adapted to take-up the release liner after the adhesive layer is transferred therefrom to a building structure, and including second clutch means operable to restrict the rotational speed thereof,
drive means drivingly connecting the tape spool and release liner take-up spindle, adapted to wind the release liner upon the take-up spindle at a speed as great as a speed at which the transfer adhesive tape material is unreeled from the tape spool,
a hand grip mounted to a base portion of said frame;
(D) applying a roofing outer coverage on at least a portion of the abutting structural panels, without applying a felt layer before applying the roofing outer coverage.

16. The method of claim 15, wherein the roofing outer coverage is selected from the group consisting of shingles, shakes, slate, and metal.

17. The method of claim 15, wherein the applicator roller has a Durometer softness selected from an index value of about 15 to about 90.

18. The method of claim 15, wherein the device further includes a roll of transfer adhesive tape material mounted on the supply spool, wherein the tape adhesive material has a width of selected from 2 to 8 inches and has a diameter selected from 3 to 10 inches, and an initial roll weight of about 2 to about 10 pounds.

19. The method of claim 15, where the water resistant seam tape comprises a single-sided adhesive tape and is devoid of a release liner.

20. The method of claim 15, wherein the device drive means comprises a gear train wherein the rotation of the tape spool is transmitted to the take-up spindle, and wherein the gear train comprises a first gear receiving force transmitted from rotation of the supply spool and a second gear receiving the force and transmitting it to rotate the take-up spindle, and including at least two idler gears which are drivingly interconnected between the first and second gears to transmit the force therebetween.

21. The method of claim 20, wherein the first clutch means includes a first friction plate urged into contact with the first gear via spring biasing means, operable to dissipate excess speed of rotation of the tape spool; and the second clutch means includes a second friction plate urged into contact with the second gear via spring biasing means, operable to dissipate excess speed of rotation of the take-up spindle.

22. A method for installing walls, comprising:
(A) providing a wall frame;
(B) fastening a plurality of structural panels having an integral moisture barrier in an abutting arrangement onto the wall frame with fastening means;
(C) covering a gap formed between the abutting structural panels with a water resistant seam tape using a hand-held device, wherein the handheld device comprises:
a frame,
an applicator roller rotatably mounted at a forward portion of said frame, adapted to press transfer adhesive tape material comprising an adhesive layer carried on a release liner against a building structure,
a tape spool rotatably mounted to said frame, adapted to i) support a roll of the transfer adhesive material, and ii) unreel transfer adhesive material to the applicator roll as the applicator roll moves against a building structure with the adhesive layer in contact therewith, and including first clutch means operable to restrict the rotational speed thereof,
a release liner take-up spindle rotatably mounted to said frame at a position between the tape spool and the applicator roll, adapted to take-up the release liner after the adhesive layer is transferred therefrom to a building structure, and including second clutch means operable to restrict the rotational speed thereof,
drive means drivingly connecting the tape spool and release liner take-up spindle, adapted to wind the release liner upon the take-up spindle at a speed as great as a speed at which the transfer adhesive tape material is unreeled from the tape spool,
a hand grip mounted to a base portion of said frame; and
(D) applying an additional wall component on at least a portion of the abutting structural panels.

23. A method for sealing gaps or crevices associated with a building structure selected from the group consisting of abutting roofing panels, abutting wall panels, a window installation in a wall frame, a door installation in a wall frame, a plumbing vent installation in a roof, a skylight installation in a roof, and a dormer in a roof; by applying a seam tape to cover the gap or crevice using the device of claim 1.
